(19) United States
(12) Patent Application Publication
(10) Pub. No.: US 2022/0198263 A1
(43) Pub. Date: Jun. 23, 2022

(54) TIME SERIES ANOMALY DETECTION

(71) Applicant: Microsoft Technology Licensing, LLC, Redmond, WA (US)

(72) Inventors: Songtao Guo, Cupertino, CA (US); Patrick Ryan Driscoll, Oakland, CA (US); Michael Mario Jennings, San Francisco, CA (US); Robert Perrin Reeves, Castro Valley, CA (US); Bo Yang, Brighton, MA (US)

(21) Appl. No.: 17/133,222

(22) Filed: Dec. 23, 2020

(51) Int. Cl. G06N 3/08; G06F 16/23

(52) U.S. Cl. CPC G06N 3/08; G06F 16/2365; G06F 16/2379

(57) ABSTRACT

In an example embodiment, a machine-learned model is trained to specifically identify anomaly points in time series data. The model is capable of being applied in parallel to many different time series simultaneously, allowing for a scalable solution for large scale online networks. The model classifies each data point in a specified time window and outputs rich contextual information for downstream applications, such as ranking and display of the anomalous data points.

### CROSS-RELATION TO PATENT APPLICATION

The present application is related to the application entitled “TIME SERIES ANOMALY RANKING” by Songtao Guo, Robert Perrin Reeves, Bo Yang, Wan Qi Gao, William Tang, Patrick Ryan Driscoll, Shan Zhou, Taylor Shelby Burfield, and Adriana Dominique Meza, filed concurrently with the present application on the same day, hereby incorporated-by-reference in its entirety.

### TECHNICAL FIELD

The present disclosure generally relates to technical problems encountered in machine learning. More specifically, the present disclosure relates to time series anomaly detection.

### BACKGROUND

The rise of the Internet has occasioned two disparate yet related phenomena: the increase in the presence of online networks, with their corresponding user profiles visible to large numbers of people, and the increase in the use of these online networks to provide content. Online networks are able to gather and track large amounts of data regarding various entities, including organizations and companies. For example, online networks are able to track users who transition from one company to another company and thus, in aggregate, these online networks are able to determine, for example, how many users have left a particular company in a particular time period. Additional details may be known and/or added to these types of metrics, such as which companies the users left the company for, and how many users have joined the particular company during the same time period. Additionally, there are many other metrics that online networks could determine about these companies that may be of interest to users.

An issue arises, however, in determining what to do with this information. There are so many potential metrics and values for the metrics that it can be difficult to determine which metric/value may be more important to convey to users.

An additional technical issue arises in the context of large online networks. Specifically, when dealing with large online networks, the amount of data to be analyzed is enormous. As such, any potential solution would need to be scalable to operate in large online networks.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of an online network, including a data processing module referred to herein as a search engine, for use in generating and providing search results for a search query, consistent with some embodiments of the present disclosure.

FIG. 3 is a block diagram illustrating the application server module of FIG. 2 in more detail, in accordance with an example embodiment.

FIG. 4 is a diagram illustrating a model fitting window and a forecast window in a time series in accordance with an example embodiment.

FIG. 5 is a block diagram illustrating an anomaly detector in more detail, in accordance with an example embodiment.

FIG. 6 is an example of filtering and decomposition in accordance with an example embodiment.

FIG. 7 is a screen capture illustrating an insights screen of a GUI in accordance with an example embodiment.

FIG. 8 is a screen capture illustrating an anomaly report screen of a GUI in accordance with an example embodiment.

FIG. 9 is a flow diagram illustrating a method of training and using a machine learned model in accordance with an example embodiment.

FIG. 10 is a block diagram illustrating a software architecture, in accordance with an example embodiment.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a machine-learned model is trained to specifically identify anomaly points in time series data. The model is capable of being applied in parallel to many different time series simultaneously, allowing for a scalable solution for large scale online networks. The model classifies each data point in a specified time window and outputs rich contextual information for downstream applications, such as ranking and display of the anomalous data points.

### DESCRIPTION

The disclosed embodiments provide a method, apparatus, and system for training a machine-learned model using a machine learning algorithm to identify anomalous data points in discrete time series. A discrete time series comprises data points separated by time intervals. These time intervals may be regular (e.g., once a month) or irregular (e.g., each time a user logs in). While this disclosure will provide specific examples where the time intervals are regular, one of ordinary skill in the art will recognize that there may be circumstances where the techniques described in the present disclosure can be applied to discrete time series with irregular time intervals.

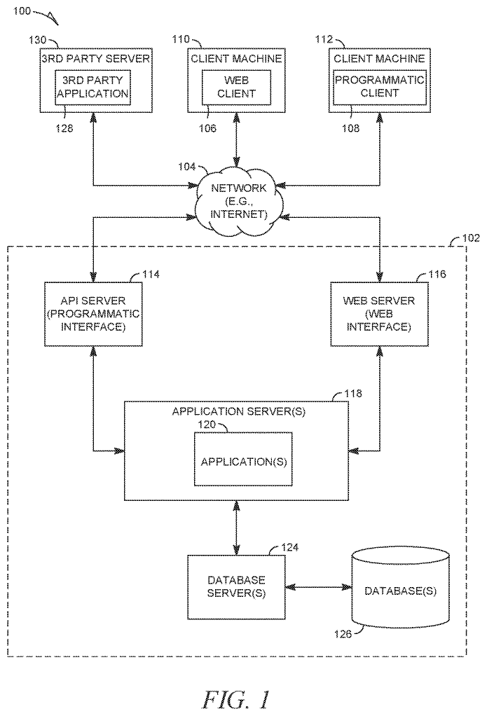

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third-party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

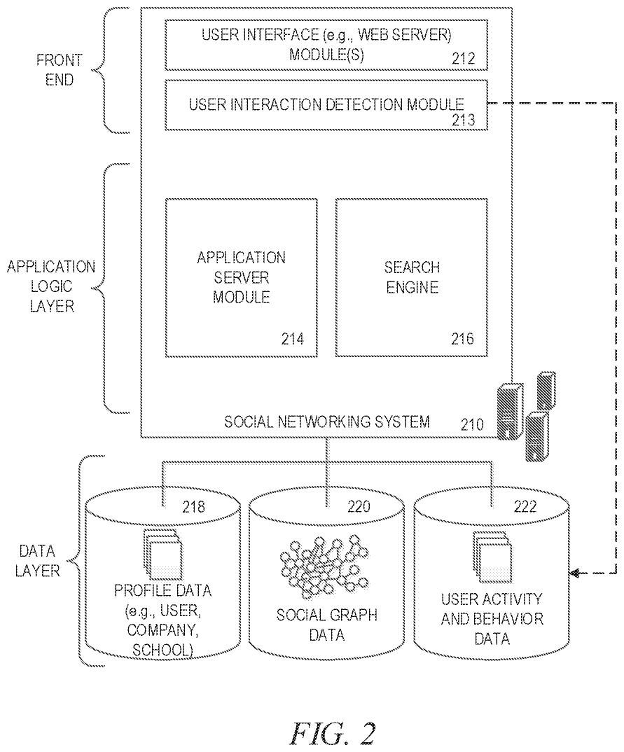

In some embodiments, the networked system 102 may comprise functional components of an online network. FIG. 2 is a block diagram showing the functional components of an online network, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices and communicates appropriate responses to the requesting client devices. For example, the user interface module(s) 212 may receive requests in the form of Hypertext Transfer Protocol (HTTP) requests or other web-based API requests. In addition, a user interaction detection module 213 may be provided to detect various interactions that users have with different applications 120, services, and content presented. As shown in FIG. 2, upon detecting a particular interaction, the user interaction detection module 213 logs the interaction, including the type of interaction and any metadata relating to the interaction, in a user activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the online network.

As shown in FIG. 2, the data layer may include several databases 126, such as a profile database 218 for storing profile data, including both user profile data and profile data for various organizations (e.g., companies, schools, etc.). Consistent with some embodiments, when a person initially registers to become a user of the online network, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the online network, the representative may be prompted to provide certain information about the organization. This information may be stored, for example, in the profile database 218, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the online network. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 220.

As users interact with the various applications 120, services, and content made available via the online network, the users' interactions and behavior (e.g., content viewed, links or buttons selected, messages responded to, etc.) may be tracked, and information concerning the users' activities and behavior may be logged or stored, for example, as indicated in FIG. 2, by the user activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API module via which applications 120 and services can access various data and services provided or maintained by the online network. For example, using an API, an application may be able to request and/or receive one or more recommendations. Such applications 120 may be browser-based applications 120 or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the online network, nothing other than data privacy concerns prevents the API from being provided to the public or to certain third parties under special arrangements, thereby making the navigation recommendations available to third-party applications 128 and services.

Although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 216 facilitates the indexing and searching for content within the online network, such as the indexing and searching for data or information contained in the data layer, such as profile data (stored, e.g., in the profile database 218), social graph data (stored, e.g., in the social graph database 220), and user activity and behavior data (stored, e.g., in the user activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

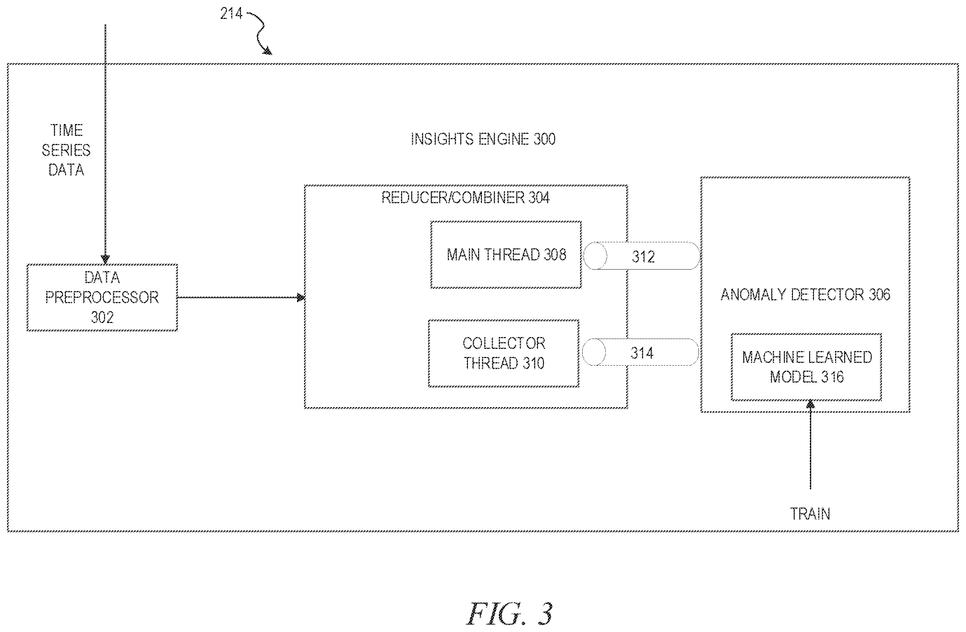

FIG. 3 is a block diagram illustrating application server module 214 of FIG. 2 in more detail, in accordance with an example embodiment. While in many embodiments the application server module 214 will contain many subcomponents used to perform various different actions within the social networking system 210, in FIG. 3 only those components that are relevant to the present disclosure are depicted.

An insights engine 300 may generate one or more insights regarding data obtained from one or more databases. These databases may include, for example, profile database 218, social graph database 220, and/or user activity and behavior database 222, among others. In an example embodiment, the insights engine 300 may include a data preprocessor 302, reducer/combiner 304, and anomaly detector 306. The data preprocessor 302 acts to gather relevant information from the databases and generates time series based on it. The preprocessing operations performed by the data preprocessor 302 may include extraction of metrics for specified segments and aggregation of those metrics into time series format. Each of a plurality of time series may then be streamed to the reducer/combiner 304 with a <key, value> pair. The key is a random key that will be used to evenly distribute tasks during parallel processing, while the value represents the time series.

In an example embodiment, the R programming language environment maybe used to implement the reducer/combiner 304. R is a computing environment for data analysis and offers a package for parallel computing. Specifically, R is capable of providing parallel in-database analytics on Hadoop databases. Hadoop databases are databases capable of storing and managing extremely large amounts of data in a distributed environment, and hence are commonly used by large-scale online networks.

The reducer/combiner 304 receives the time series via a cached R environment and scripts. It may copy and sort the time series and launch two processing threads, a main thread 308 and a collector thread 310. The main thread 308 feeds time series data to the anomaly detector 306 via pipe 312. The anomaly detector 306 then feeds identified anomalies to the reducer/combiner 304 via pipe 314. The reducer/combiner 304 is then able to output the anomalies and their classifications and context.

This provides an efficiently scalable solution built on top of an open-source cloud framework and providing reliable time series analysis. It allows for billions of time series to be evaluated daily without depending on commercial time series engines. In prior art software solutions, anomaly detection needed to be handled serially, and thus anomaly detection in time series data on the scale of millions or even billions of data points could not be performed in a reasonable amount of time. In an example embodiment, the anomaly detection is able to be performed on each time series in parallel, training a model for a particular time series to detect anomalies in data later in the time series using data from earlier in the time series, allowing anomaly detection in time series data on the scale of millions or billions of data points to be performed in a reasonable amount of time by parallelizing the computations.

Specifically, when analysing data for large companies, such as a company with hundreds of thousands of employees, and when that data is collected via user profile information, such as user profiles collected and stored by a social network service where users list their current employer (and sometimes prior employers), it can be quite time consuming to collect and analyze the data. To determine a headcount for the current month, for example, all user profiles from the current month are scanned to identify users who have listed the company (or a related entry) as a current employer. Then if the analysis provider wanted to provide an analysis for hundreds, thousands, or even hundreds of thousands of employees, this process would need to be repeated for every company. Additionally, the entire process would need to be repeated periodically (e.g., every month) to compute the time series for each employer. Then this data needs to be fed into an analysis component to perform data analysis on all data in the time series. By excluding some of the data in the time series (the forecast window) from being used to train the model, this saves computations on that time series data in the forecast window.

Thus, if three years worth of data were provided in a time series, prior art solutions would identify anomalies in those three years worth of data by analysing all three years worth of data. In an example embodiment, a forecast window length of one year and a model fitting window length of two years would mean that only the first two years of the three years of data would be used to identify anomalies, and it would only be used to identify anomalies in the most current one year of the three years of data. Thus, it saves calculations both by reducing the number of data points used to make predictions and reducing the number of data points on which those predictions will be made.

Additional savings are provided by the fact that prior art solutions involving predictions of values for time series data utilize models trained on more than one time series (typically trained on the entirety of available time series data, potentially broken down by industry). In an example embodiment, the training of the model is performed only on the data from the time series of interest, allowing that model training to be performed in parallel with training of models for other time series. For example, if the available data included three years worth of information for fifty different companies, prior art machine learning solutions would train a global model using all three years worth of information for all companies and use that global model to predict future time series data. In an example embodiment with the forecast window length of one year and model fitting window length of two years, fifty different models would be trained, each only using the first two years data in the corresponding time series for the training. By training them independently, the training is able to be parallelized to improve performance.

The anomaly detector 306 implements a machine learned model 316 that compares a data point in the time series with an estimation. The estimation is performed using time series analysis and the result represents the machine learned model's expectation of a value at the given time with a particular confidence level. Thus, for example, the estimation may indicate that employee headcount at a particular time point (e.g., April, 2020) in the time series should be between 150 and 160, and an actual value for that time point may be compared with the estimation to determine whether it was anomalous.

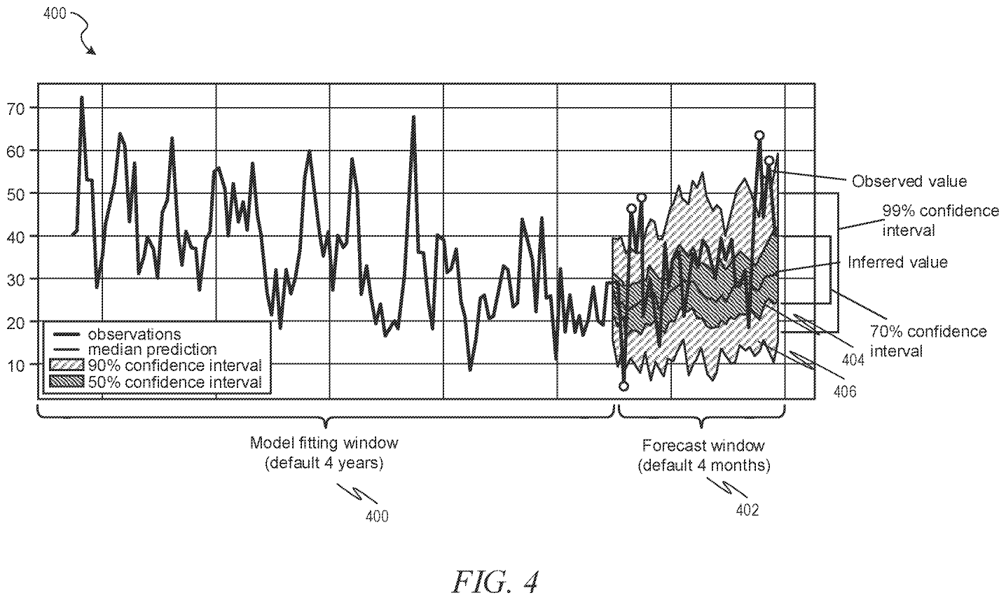

Notably, the machine learned model 316 can, for a given time series, split the time series into two windows, a model fitting window and a forecast window. FIG. 4 is a diagram illustrating a model fitting window 400 and a forecast window 402 in a time series in accordance with an example embodiment. The forecast window 402 represents data points that have occurred recently, with “recent” being defined as a predetermined number of time intervals from a current time period. For example, if the time intervals in the time series are months, the forecast window 402 may include data points from the past 4 months, with older data points being in the model fitting window 400.

While in some example embodiments, the length of the forecast window 402 may be predetermined and fixed, in other example embodiments this length may be variable and/or dynamic. Indeed, this length may be personalized for different contexts. For example, certain types of time series may have longer forecast window 402 lengths than others, or it may be customized based on the company the data applies to, or to the viewer. In an example embodiment, a mapping between contexts and lengths may be maintained such that the process involves determining a current context, retrieving a corresponding length from the mapping, and using that length for the forecast window. In another example embodiment, another machine learned model can be trained to output a length for an input context/user/company. For example, data about past interactions by user A (or users similar to user A) with a graphical user interface displaying anomalous data points can be used to train a model that predicts the forecast window length that has the highest probability of causing user A to interact with the results of the time series analysis provided in the graphical user interface.

In an example embodiment, the dynamic forecast window length may be determined by first obtaining past interactions in a group of sample data. This group may be determined based on a common characteristic (whether broad or narrow) among the sample data in the group, and the common characteristic can be selected to be any attribute that one would want to “personalize” or customize the length for. In the narrow case, sample data only pertaining to an individual user and users similar to the individual user (as determined by more than a threshold similarity of user profile information, such as employment history, education, location, and skills) can be obtained. In a more broad case, sample data pertaining to all users employed at a particular employer can be obtained. No matter the common characteristic, the sample data may include interactions between users and anomalies presented in a graphical user interface. These interactions may be positive (such as selecting on or hovering over the presented anomaly to view additional information about the presented anomaly), or negative (such as having been presented with the anomaly but not selecting it, or dismissing it if such an option is provided). The positive and negative interactions may be labelled as positive or negative, respectively, and fed to a machine learning algorithm to train a specialized forecast window length determination machine learned model. The training may include learning weights (coefficients) to be applied to feature data about users. The forecast window length determination machine learned model may then apply these weights to feature data for a particular user to which the graphical user interface may be currently presented, outputting a specialized forecast length for the particular user, thus dynamically determining the forecast window length and potentially affecting which anomalies are presented to the particular user. For example, if a user consistently selected on anomalies within the last 6 months and no older, then a forecast window length that was previously set to 12 months may be altered to be 6 months.

A similar process may be undertaken to dynamically determine the length of the model fitting window.

Referring back to the machine learned model used to predict values for a data point in a time series, this model is able to output ranges of predicted values for the data point, at different confidence levels. This is also depicted in FIG. 4. As can be seen, here the machine learned model has output a 70% confidence interval 404 and a 99% confidence interval 406, although the machine learned model is able to output any number of different confidence interval ranges.

Data values in the forecast window that are outside of a selected confidence interval are considered to be anomalous. In an example embodiment, the 99% confidence interval 406 range is the one that is used to classify whether a data point is anomalous or not. However, it should be noted that it is not necessary that this selection be fixed or predetermined. As with the forecast window 402 length, in other example embodiments this length may be variable and/or dynamic. Indeed, this selection may be personalized for different contexts. For example, certain types of time series may use a 99% confidence interval while others may use a 95% confidence interval, or the interval may be customized based on the company the data applies to, or to the viewer. This determination may be made by a classification component, as will be described below. In some example embodiments, the machine learning algorithm may be used to learn the confidence interval percentage based on user interactions with information displayed about anomalies by a reporting tool of a graphical user interface. Thus, for example, a user who routinely clicks on displayed anomalies in the reporting tool may cause the machine learned model to be retrained to adjust the confidence interval down from 99% to 95% to detect more anomalies.

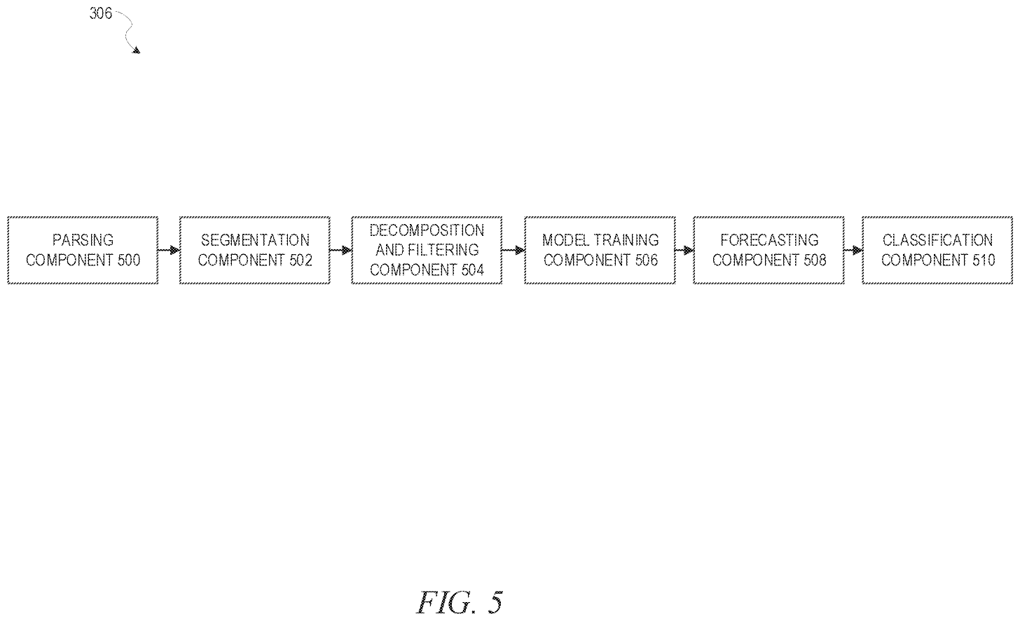

FIG. 5 is a block diagram illustrating an anomaly detector 306 in more detail, in accordance with an example embodiment. Here, the anomaly detector 306 includes a parsing component 500. Parsing component 500 parses the raw input and creates a normalized time series. For example, in a monthly time series, it is expected that every month in a given time range should have a valid value, even if it is zero. If the raw input is missing a data point for a given month, the parsing component 500 infers it. In an example embodiment, this inferring is performed by interpolating values around the missing data point. For example, if values are present for all months of 2020 except for April, the parsing component 500 may infer a value for April by averaging the values for March and May.

Segmentation component 502 segments the time series into a model fitting window and a forecast window, as described above. This provides a good tradeoff between freshness of data and accuracy (which is influenced by data maturity).

A decomposition and filtering component 504 then acts to filter any time series that does not meet some minimum requirements. For example, if a time series is too short to even cover the forecast window, or does not meet some other defined minimal length requirement, it may be filtered out. For any other non-filtered out time series, the decomposition and filtering component 504 may then act to decompose the model fitting window portion of the time series into trend, seasonal, and noise components for modelling. This allows the forecast window in each time series to essentially have its own model based on the data in the model fitting window of the same time series. Notably, outliers in the model fitting window can negatively impact the estimation in the forecast window. Such outliers may be removed. The goal is to form a new time series within the model fitting window with modified components that aid in the ability for the machine learned model to make its predictions and classifications.

Specifically, the time series T is decomposed to a trend C_{trend}, up to M seasonal components Cₛₑₐₛₒₙₐₗ and a noise (remainder) component Cₙₒᵢₛₑ

T=C_{trend}+Cₛₑₐₛₒₙₐₗ₁ . . . + . . . +C_{SeasonalM}+Cₙₒᵢₛₑ

A running median is used (with default window size) to augment the Trend component (C_{trend}). The augmented trend component is denoted as

C′_{trend}=runmed(C_{trend},k_{window-size}).

A new noise component is generated: C′ₙₒᵢₛₑ=Cₙₒᵢₛₑ+C_{trend}−C′_{trend}

This is accomplished by first decomposing the time series data into trend, seasonal, and noise components. There is only one trend component and only one noise component for each time series, but there may be one or more seasonal components. MSTL may be used for this process.

MSTL is a function that handles potentially multiple seasonability time series. It operates by iteratively estimating each seasonal component using a seasonal-trend decomposition such as STL. The trend component is computed for the last iteration of STL. STL is a filtering procedure for decomposing a seasonal time series. STL comprises two recursive procedures: an inner loop nested inside an outer loop. In each of the passes through the inner loop, the seasonal and trend components are updated once. Each complete run of the inner loop comprises n₍ᵢ₎ such passes. Each pass of the outer loop comprises the inner loop followed by a computation of robustness weights. These weights are used in the next run of the inner loop to reduce the influence of transient, aberrant behavior on the trend and seasonal components. An initial pass of the outer loop is carried out with all robustness weights equal to 1, and then n(o) passes of the outer loop are carried out. In an example embodiment, n(o) and n(i) are preset and static.

Each pass of the inner loop comprises a seasonal smoothing that updates the seasonal component, followed by a trend smoothing that updates the trend component. Specifically, a detrended series is computed. Then each subseries of the detrended series is smoothed by a smoother such as a Loess smoother. Low pass filtering is then applied to the smoothed subseries, and a seasonal component is subtracted from the smoothed and filtered subseries. This is known as detrending the smoothed subseries. A deseasonalized series is then computed. The deseasonalized series is then smoothed (such as by using a Loess smoother).

An outer loop then defines a weight for each time point where the time series does not have missing values. These weights are known as robustness weights and reflect how extreme the remainder is (the time series minus the trend component minus the seasonal component). The robustness weights may be computed using a bisquare weight function. The inner loop is then repeated, but in the smoothings, a neighbourhood weight for a value at a particular time is multiplied by the corresponding robustness weight.

The iterations may continue until a preset number of iterations has occurred.

Outlier detection is then performed on the noise component (C′ₙₒᵢₛₑ) and detected noises are removed. An outlier free noise component is denoted as C″ₙₒᵢₛₑ

A new time series is then formed with modified components:

T=T−(C′ₙₒᵢₛₑ−C″ₙₒᵢₛₑ)

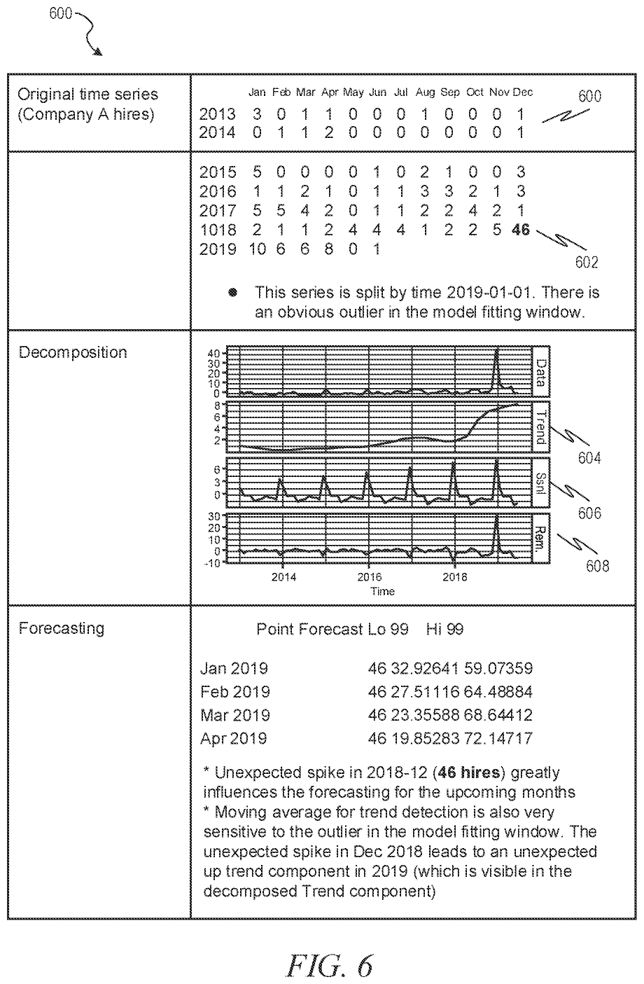

FIG. 6 is an example of filtering and decomposition in accordance with an example embodiment. The time series data 600 represents number of hires for a particular company over time. Notably, there is an obvious outlier 602 in December 2018. It may be assumed that the model fitting window includes the years 2017 and 2018, and thus this outlier 602 could significantly affect the prediction for the forecast window (which includes 2019), making it more difficult to detect anomalies in the forecast window. In order to recognize that this outlier 602 is indeed an outlier, however, the time series data 600 in the model fitting window is decomposed into trend component 604, seasonal component 606, and remainder component 608 (essentially noise). While the seasonal component 606 indicates that there is some seasonality to hiring, the fact that even once this component is decomposed out there still remains a fairly strong remainder component 608 in December 2018 is indicative of this point being an outlier. It could therefore either be removed or simply modified to a more “typical” level prior to being used in forecasting (i.e., either simply ignore the December 2018 data point or change “46” to “3” to be more in line with past seasonal hiring trends, such as by averaging surrounding values). In this context, an outlier, such as outlier 602, is defined as any value that is above or below other values in the time series by more than a predetermined amount or percentage.

Referring back to FIG. 5, model training component 506 then trains the machine learned model using the (potentially modified) time series data in the model fitting window. In an example embodiment, Exponential Smoothing (ETS) and Auto Regressive Integrated Moving Average (ARIMA) are utilized during this process.

The machine learning algorithm may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. In an example embodiment, a binary logistical regression model is used. Binary logistic regression deals with situations in which the observed outcome for a dependent variable can have only two possible types. Logistic regression is used to predict the odds of one case or the other being true based on values of independent variables (predictors).

A neural network is a deep learning machine learning model that contains layers of interconnected nodes. Each node is a perceptron and is similar to multiple linear regression. The perceptron feeds the signal produced by multiple linear regression into an activation function that may be nonlinear. In a multi-layered perceptron (MLP), perceptrons are arranged in interconnected layers. The input layer collects input patterns. The output layer has classifications or output signals to which input patterns may map.

Hidden layers fine-tune the input weightings until the neural network's margin of error is minimal. The hidden layers extrapolate salient features in the input data that have predictive power regarding the outputs.

In an example embodiment, the machine learned model may also be retrained at a later time based on feedback received by users or based on additional (e.g., new) training data received over time since the previous training. The feedback may be in the form of interactions of viewers (users) with a reporting tool of a graphical user interface that displays information about anomalies. Thus, for example, if a particular user or type of user winds up interacting significantly with detected anomalies displayed in the reporting tool, then this interaction may be used to retrain the model, possibly resulting in the length of the forecast window changing and/or the confidence interval percentage changing.

A forecasting component 508 may then apply the trained model to generate forecasts for the data in the time series in the forecasting window. This returns, for each data point, a forecasted value (vₜ′) and a desired level of prediction intervals ([z_{lower},zᵤₚₚₑᵣ]) based on the desired prediction level confidence (e.g., 99%). A prediction interval quantifies the uncertainty on a single observation estimated from the population. It is different from the confidence interval, which quantifies the uncertainty on an estimated population variable, such as a mean or standard deviation. Prediction intervals are wider than confidence intervals because they account for the uncertainty associated with an irreducible error.

A classification component 510 may then compare each data point with the prediction interval, and if it falls outside of the prediction interval (either lower than z_{lower} higher than zᵤₚₚₑᵣ, then it is classified as an anomaly. In some instances, a distinction is made in the classification between a low anomaly (one in which the value falls below the prediction interval) and a high anomaly (one in which the value is above the prediction interval), which may be used later when ranking and/or display is performed for the anomaly.

The classification component 510 may also append contextual information as metadata to the resulting classification. This contextual information may include the following:

| | |
|---|---|
| timeseries_json | json representation of the full time series |
| trend_json | json representation of the trend component of the given |
| | time series (with zero removed) |
| seasonal_json | json representation of the seasonal component of the |
| | given time series(with zero removed) |
| outlier_strength | [0, 1] score measuring the strength of outlier |
| training.df_length | number of data points in the effective training data |
| timestamp | timestamp of the data point in the insights window |
| observed_value | observed value at the given time |
| predicted_value | inferred value at the given time |
| nperiods | number of seasonal periods (1 for non-seasonal data) |
| seasonal_period | a vector of seasonal periods defined by frequency |
| | (1 for non-seasonal data) |
| trend | strength of trend |
| spike | measures the “spikiness” of a time series, and is |
| | computed as the variance of the leave-one-out |
| | variances of the remainder component Cₙₒᵢₛₑ |
| linearity | measures the linearity of a time series calculated based |
| | on the coefficients of an orthogonal quadratic |
| | regression |
| curvature | measure the tendency of the time series in the time |
| | neighborhood |
| e_acfl | the first autocorrelation coefficient |
| e_acf10 | the sum of the first ten squared autocorrelation |
| | coefficients |
| seasonal_strength | strength of seasonality. For non-seasonal |
| | time series seasonal.strength is 0. For seasonal time |
| | series, seasonal.strength is an M-vector, where M is |
| | the number of periods. |
| | * S_{seasonality} = 1 − var(Cₙₒᵢₛₑ)/var(Cₛₑₐₛₒₙₐₗ, + Cₙₒᵢₛₑ) |
| | * Caped to [0, 1] |
| peak | month of the year for the peak |
| trough | month of the year for the trough |

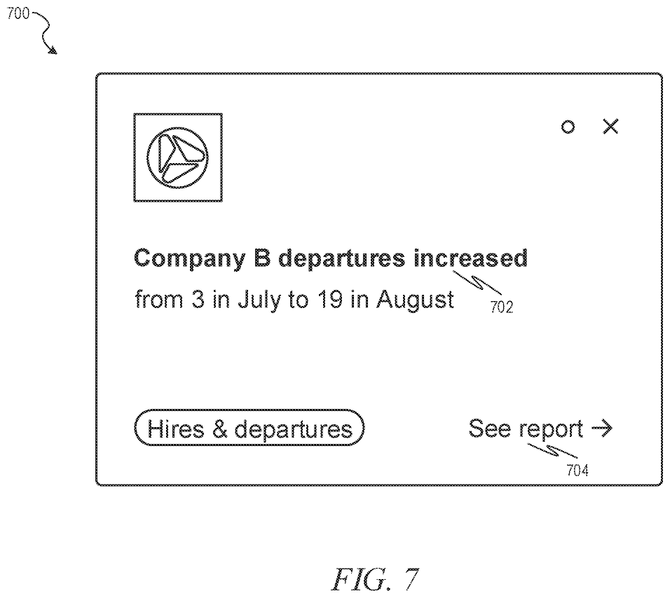

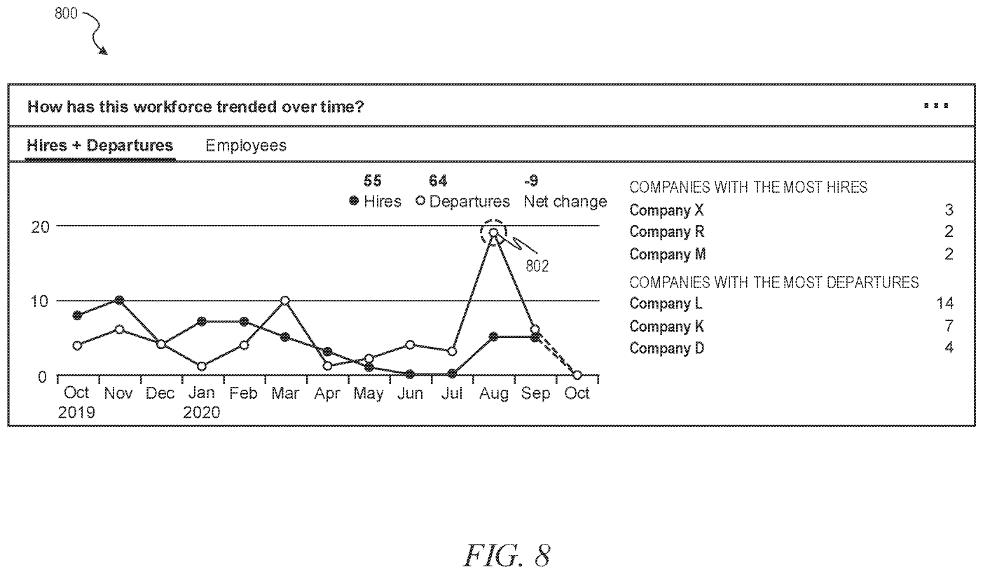

FIGS. 7 and 8 are examples of graphical user interfaces (GUIs) presenting insights regarding the anomalies detected using the above method. FIG. 7 is a screen capture illustrating an insights screen 700 of a GUI in accordance with an example embodiment. Here, a text indication 702 of the anomaly is presented, along with a link 704 for the viewer to select to see the entire report. Selection of link 704 causes the GUI in FIG. 8 to be launched. FIG. 8 is a screen capture illustrating an anomaly report screen 800 of GUI in accordance with an example embodiment. Here, anomaly 802 is highlighted graphically to illustrating where the anomaly is in the time series and how different it is from other data points. User selection of the anomaly 802 and/or other anomalies in the anomaly report screen 800 (and/or other anomaly report screens) may cause the model to dynamically alter the confidence interval percentage and/or length of the forecast window in future time series analysis, through retraining of the model.

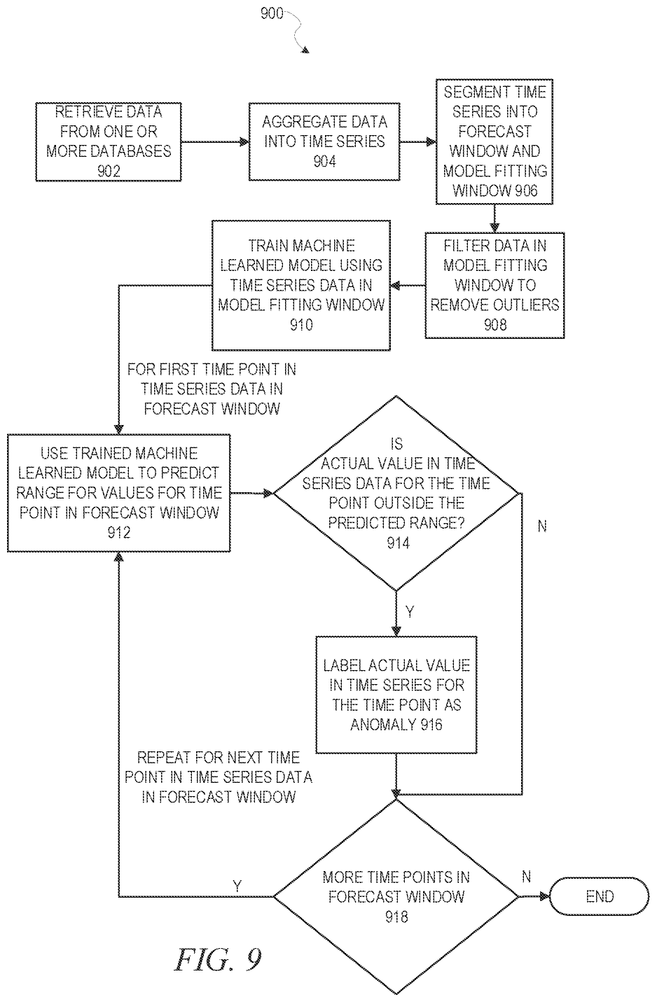

FIG. 9 is a flow diagram illustrating a method 900 of training and using a machine learned model in accordance with an example embodiment. At operation 902, data is retrieved from one or more databases. At operation 904, the data is aggregated into time series data. At operation 906, the time series data is segmented into a forecast window and a model fitting window. The forecast window includes the time series data for the particular time point and time series data for time points no earlier than a particular time point of the plurality of time points and the model fitting window includes time series data no later than the particular time point.

At operation 908, the data in the model fitting window is filtered to remove outliers, specifically by decomposing the data into trend, seasonal, and remainder components and identifying outliers based on the remainder component. At operation 910, a machine learned model is trained, using the time series data in the model fitting window, to predict a range of data values for a time point in the forecast window. This range may be based on a certain percentage confidence interval, with the percentage being learned during model training. Specifically, the percentage confidence interval is a value indicating the size of the confidence interval, and this value may be learned during machine learning based on user interaction data, as described earlier.

A loop is then begun for each of one or more time points in the forecast window. At operation 912, the machine learned model is used to predict the range of values for the corresponding time point in the forecast window. At operation 914, it is determined if the actual value in the time series data for the corresponding time point is outside the predicted range. If so, at operation 916 the actual value in the time series for the corresponding time point is labelled as an anomaly. If not, the method 900 skips to operation 918 without executing operation 916. At operation 918, it is determined if there are any more time points in the forecast window. If so, the method 900 loops back to operation 912 for the next time point in the time series data in the forecast window. If not, the method 900 ends.

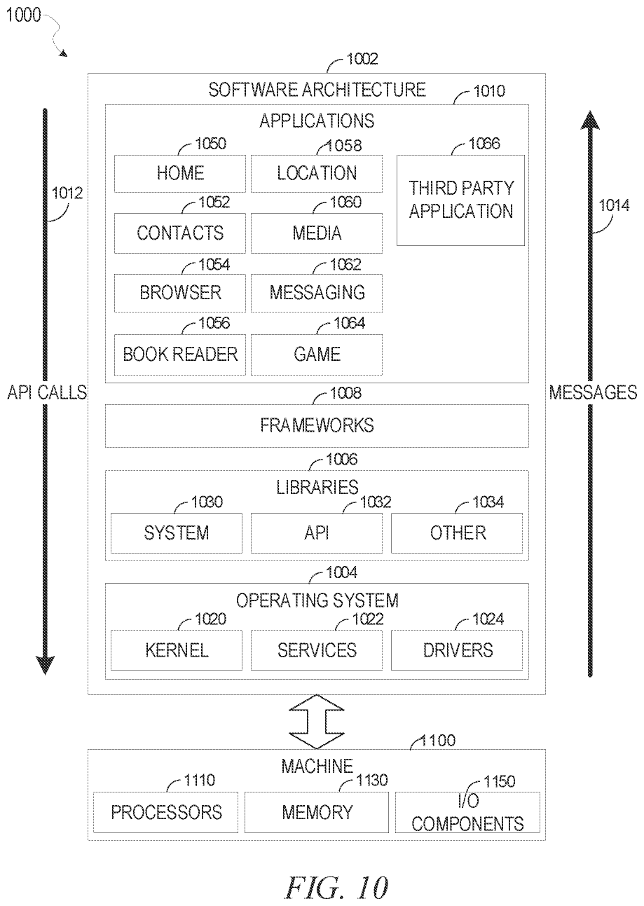

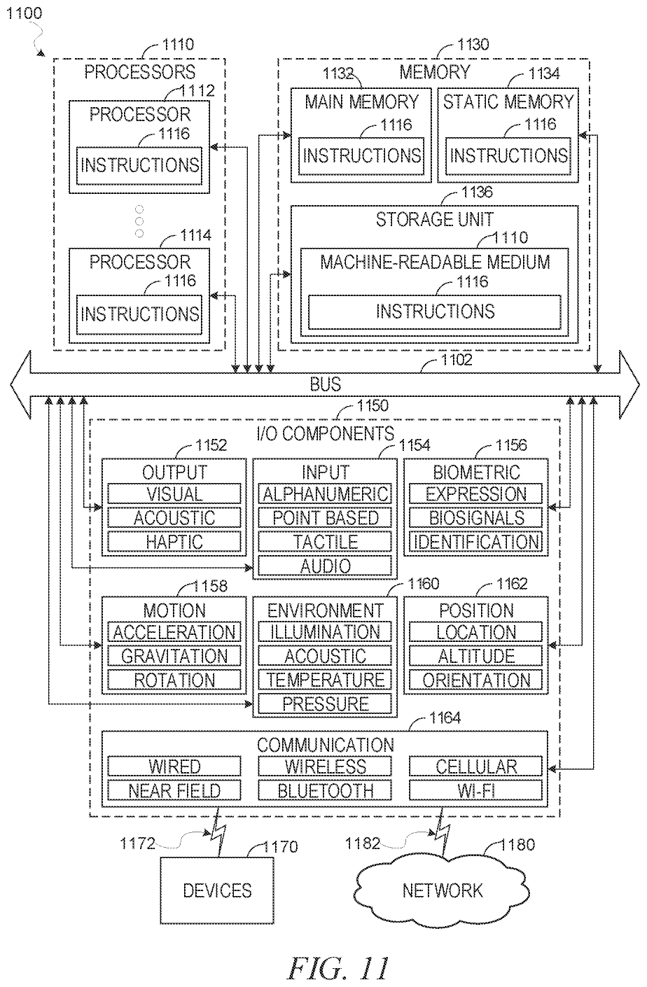

FIG. 10 is a block diagram 1000 illustrating a software architecture 1002, which can be installed on any one or more of the devices described above. FIG. 10 is merely a non-limiting example of a software architecture, and it will be appreciated that many other architectures can be implemented to facilitate the functionality described herein. In various embodiments, the software architecture 1002 is implemented by hardware such as a machine 1100 of FIG. 11 that includes processors 1110, memory 1130, and input/output (I/O) components 1150. In this example architecture, the software architecture 1002 can be conceptualized as a stack of layers where each layer may provide a particular functionality. For example, the software architecture 1002 includes layers such as an operating system 1004, libraries 1006, frameworks 1008, and applications 1010. Operationally, the applications 1010 invoke API calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphical user interface functions, high-level resource management, high-level location services, and so forth. The frameworks 1008 can provide a broad spectrum of other APIs that can be utilized by the applications 1010, some of which may be specific to a particular operating system 1004 or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications, such as a third-party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate functionality described herein.

FIG. 11 illustrates a diagrammatic representation of a machine 1100 in the form of a computer system within which a set of instructions may be executed for causing the machine 1100 to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application 1010, an applet, an app, or other executable code) for causing the machine 1100 to perform any one or more of the methodologies discussed herein may be executed. For example, the instructions 1116 may cause the machine 1100 to execute the method 900 of FIG. 9. Additionally, or alternatively, the instructions 1116 may implement FIGS. 1-9, and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors 1112 (sometimes referred to as “cores”) that may execute instructions 1116 contemporaneously. Although FIG. 11 shows multiple processors 1110, the machine 1100 may include a single processor 1112 with a single core, a single processor 1112 with multiple cores (e.g., a multi-core processor), multiple processors 1110 with a single core, multiple processors 1110 with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine 1100 will depend on the type of machine 1100. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various example embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1130, 1132, 1134, and/or memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to the processors 1110. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1180 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1116 may be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system for training and using a machine learned model, comprising:
a computer-readable medium having instructions stored thereon, which, when executed by a processor, cause the system to perform operations comprising:
obtaining time series data, the time series data including a value for a first metric at each of a plurality of time points separated by time intervals;
segmenting the time series data into a forecast window and a model fitting window, the forecast window including time series data for a particular time point of the plurality of time points and time series data for time points no earlier than the particular time point of the plurality of time points and the model fitting window including time series data no later than the particular time point;
training a machine learned model, using the time series data in the model fitting window, to predict a range of data values for a time point in the forecast window;
for each of one or more time points in the forecast window:
comparing the value for the corresponding time point with the range of data values predicted by the machine learned model for the corresponding time point; and
labeling the value of the corresponding time point as an anomaly if the value falls outside the range of data values predicted by the machine learned model for the corresponding time point.

2. The system of claim 1, wherein the operations further comprise retraining the machine learned model based on user feedback.

3. The system of claim 1, wherein a size of the model fitting window is dynamically determined based on an entity to which the time series data pertains.

4. The system of claim 1, wherein the operations further comprise generating a graphical user interface in which values labeled as anomalies are graphically highlighted.

5. The system of claim 4 wherein a size of the model fitting window is dynamically determined based on a viewer of a graphical user interface.

6. The system of claim 1, wherein a size of the forecast window is dynamically determined based on an entity to which the time series data pertains.

7. The system of claim 4, wherein a size of the forecast window is dynamically determined based on a viewer of the graphical user interface.

8. The system of claim 1, wherein the particular time point is dynamically determined based on an entity to which the time series data pertains.

9. The system of claim 4, wherein the particular time point is dynamically determined based on a viewer of the graphical user interface.

10. The system of claim 1, wherein the machine learned model is a neural network.

11. The system of claim 1, wherein the time series data is passed through a reducer/combiner that sorts multiple time series to be passed individually to different parallel processes, each parallel process performing the segmenting, training, comparing, and labeling independently from one another.

12. The system of claim 1, wherein the time series data in the model fitting window is filtered to remove outliers.

13. The system of claim 12, wherein the time series data in the model fitting window is decomposed into a trend component, seasonal component, and remainder component, and the outliers in the time series data in the model fitting window are identified based on the remainder component.

14. A computerized method comprising:
obtaining time series data, the time series data including a value for a first metric at each of a plurality of time points separated by time intervals;
segmenting the time series data into a forecast window and a model fitting window, the forecast window including time series data for a particular time point of the plurality of time points and time series data for time points no earlier than the particular time point of the plurality of time points and the model fitting window including time series data no later than the particular time point;
training a machine learned model, using the time series data in the model fitting window, to predict a range of data values for a time point in the forecast window;
for each of one or more time points in the forecast window:
comparing the value for the corresponding time point with the range of data values predicted by the machine learned model for the corresponding time point; and
labeling the value of the corresponding time point as an anomaly if the value falls outside the range of data values predicted by the machine learned model for the corresponding time point.

15. The method of claim 14, further comprising retraining the machine learned model based on user feedback.

16. The method of claim 14, wherein a size of the model fitting window is dynamically determined based on an entity to which the time series data pertains.

17. The method of claim 14, further comprising generating a graphical user interface in which values labeled as anomalies are graphically highlighted.

18. The method of claim 17, wherein a size of the model fitting window is dynamically determined based on a viewer of a graphical user interface.

19. The method of claim 14, wherein the time series data is passed through a reducer/combiner that sorts multiple time series to be passed individually to different parallel processes, each parallel process performing the segmenting, training, comparing, and labeling independently from one another.

20. A non-transitory machine-readable storage medium comprising instructions which, when implemented by one or more machines, cause the one or more machines to perform operations comprising:
obtaining time series data, the time series data including a value for a first metric at each of a plurality of time points separated by time intervals;
segmenting the time series data into a forecast window and a model fitting window, the forecast window including time series data for a particular time point of the plurality of time points and time series data for time points no earlier than the particular time point of the plurality of time points and the model fitting window including time series data no later than the particular time point;
training a machine learned model, using the time series data in the model fitting window, to predict a range of data values for a time point in the forecast window;
for each of one or more time points in the forecast window:
comparing the value for the corresponding time point with the range of data values predicted by the machine learned model for the corresponding time point; and
labeling the value of the corresponding time point as an anomaly if the value falls outside the range of data values predicted by the machine learned model for the corresponding time point.
